(19) United States
(12) Patent Application Publication
(10) Pub. No.: US 2001/0004752 A1
(43) Pub. Date: Jun. 21, 2001

(54) Communication interface between processors and semiconductor integrated circuit apparatus

(76) Inventors: Kazumasa Suzuki, Tokyo (JP); Ryuuji Ishida, Tokyo (JP)

Correspondence Address: Whitham, Curtis & Whitham, Reston International Center, Suite 900, 11800 Sunrise Valley Dr., Reston, VA, 20191, US

(21) Appl. No.: 09/736,429

(22) Filed: Dec. 15, 2000

(30) Foreign Application Priority Data
Dec. 17, 1999 (JP) 11-359705

(51) Int. Cl. G06F 13/00; G06F 13/38

(52) U.S. Cl. 710/130

(57) ABSTRACT

In the LSI, in which a plurality of the operational units are loaded in one chip, transmission buffers are disposed associated with the operational units. Reception flags and transmission flags showing states of reception buffers are assigned to each bit of a register, which is capable of being accessed from the host processor. The transmission flags are combined into one signal using OR circuits and the reception flags are combined into one signal using AND circuits, so that the combined flags are assigned to an outer pin. At first, the access from the host processor refers to a reception flag signal and a transmission flag signal of the outer pin. Then, it reads the transmission flag register and the reception flag register, checks the states of the transmission buffers and the reception buffers to access necessary transmission buffers and reception buffers.

### FIELD OF THE INVENTION

The present invention relates to an interface circuit between processors. More specifically, the present invention relates to an interface circuit for communicating with an outer host processor in a LSI (Large Scale Integration), which is installed with a plurality of processors.

### BACKGROUND OF THE INVENTION

In an arithmetic processing system being provided with a processor, a system being provided with a plurality of subprocessors is used for performing arithmetic processing mainly by a host processor in order to have an increase in speed and capability of the arithmetic processing system.

A communication function between processors is important for a system comprising a host processor and a plurality of subprocessors. FIG. 1 shows an example of a conventional communication system construction between processors. With reference to FIG. 1 a subprocessor LSI30a is provided with a transmission buffer 32a, a reception buffer 33a, a transmission flag 34a showing there is data in the transmission buffer 32a and a reception flag 35a showing the reception buffer 33a is vacant as means for communicating with an outer host processor 40.

For data communication with the host processor 40, the transmission buffer 32a is connected to a data bus 201 in the outside of a chip via a transmission driver 36a and the reception buffer 33a is connected to the data bus 201 in the outside of the chip via a reception driver 37a. A subprocessor LSI30b also has the same construction as that of the subprocessor LSI30a. Alternatively, the reception flag 35a may be constructed so as to be logic “1” when there is data in the reception buffer 33a, not as to be logic “1” when the reception buffer 33a is vacant.

In the case of designating a processor to be accessed, the host processor 40 transmits an address signal to an address bus 200 and provides chip selection signals 205a and 205b with respect to the subprocessors LSI30a and LSI30b of the address, which is decoded and assigned by a decoder 41.

The host processor 40 transmits (writes) data to the subprocessor LSI in such a manner that, the data to be transmitted to the data bus 201 is output, a write enable signal 202 is asserted and data is written in the subprocessor LSI, in which a chip selection signal is asserted.

The host processor 40 reads data from the subprocessor LSI, in such a manner that asserting a read enable signal 203, the subprocessor, which the chip selection signal is asserted, outputs the data of the reception buffer to the data bus 201 and the host processor 40 reads the data on the data bus 201.

It is confirmed that there is data in the transmission buffers 32a and 32b and the reception buffers 33a and 33b are capable of being written by with reference to the transmission flags 34a and 34b and the reception flags 35a and 35b. Values of these flags are output to an outer signal pin of the chip and the host processor 40 obtains a value of a flag signal 204 by using a general port or the like.

LSI products are developed and manufactured, which are highly integrated by advance of minimization of a semiconductor and a plurality of operational units are loaded in a chip. However, because of restriction of a size of a package or the like, the number of the outer signal pins is limited.

When the construction illustrated in FIG. 1 is loaded on the same chip with a plurality of operational units as they are, the reception flag, the transmission flag, the write enable signal, the read enable signal and the chip selection signal are needed by the same number as that of the operational unit. Therefore, it has effect on restriction of the number of pins.

Alternatively, in view of consistency and compatibility with respect to a conventional system, it is required that a system should be capable of being constructed with maintaining the same connection state and interface format.

With respect to reading the reception data from a plurality of interface circuits at a MPU, in the case that any one of the flags, which are set so as to be associated with an input channel, is in a data reception holding state, for example, Japanese Patent Application Laid-Open Publication No. 64-17143 suggests a data reception system for generating data reading requirement interruption in the side of data processing (MPU), identifying an input channel compliant to data reception in the side of the data processing depending on a content of an input channel associated flag group, which is read on the basis of this interruption and reading the received data with this input channel compliant holding state. However, in Japanese Patent Application Laid-Open Publication No. 64-17143, there is no consideration with respect to identification of a problem of increase of the outer pin when a plurality of interface circuits are loaded on the same plural chips.

### SUMMARY OF THE INVENTION

The present invention has been made taking the foregoing problem into consideration, an object of which is to provide an apparatus for suppressing increase of the number of the pins and decreasing the pins even when a plurality of operational units are loaded in one LSI.

Other object of the present invention is to provide an apparatus for enabling connection to the processor and access operation by the same construction as that of the conventional system even when the number of controlling signal pin is decreased.

The present invention to attain the foregoing object comprises an integrated circuit apparatus including a plurality of operational units; wherein a plurality of the operational units transmit data to a processor in the outride of the integrated circuit apparatus via transmission buffers, which are disposed associated with each of the operational units, respectively, a register group, in which transmission flags showing there is data in each of the transmission buffers or not are assigned in different bit positions, respectively and means for enabling the register group to be referred at the same time from the processor in the outside of the integrated circuit apparatus.

According to the present invention, an outer terminal may be provided to output a logical addition output of the value of each element of a register group to the outside.

Alternatively, the present invention comprises an integrated circuit apparatus including a plurality of operational units; wherein a plurality of the operational units transmit data to a processor in the outside of the integrated circuit apparatus via reception buffers, which are disposed associated with each of the operational units, respectively, a register group in which reception flags showing each of the reception buffers is vacant or not are assigned in different bit positions, respectively and means for enabling the register group to be referred at the same time from the processor in the outside of the integrated circuit apparatus.

According to the present invention, an outer terminal may be provided to output a logical product output of the value of each element of a register group to the outside.

### BRIEF DESCRIPTION OF THE DRAWINGS

FIG. 1 shows a connection state between a communication interface circuit and a host processor in a conventional subprocessor.

FIG. 2 shows a constitution of an example of the present invention;

FIG. 3 shows a connection state between a host processor and a subprocessor LSI according to an example of the present invention;

FIG. 4 shows a connection state between a host processor and a subprocessor LSI according to an example of the present invention;

PIG. 5 shows timing waveforms for explaining the operation of reading data from the subprocessor to the host processor LSI according to an example of the present invention;

FIG. 6 shows timing waveforms for explaining the operation of writing data from the subprocessor to the host processor LSI according to an example of the present invention;

FIG. 7 shows a constitution of another example of the present invention;

FIG. 8 shows timing waveforms for explaining the operation of writing data from the subprocessor to the host processor LSI according to another example of the present invention.

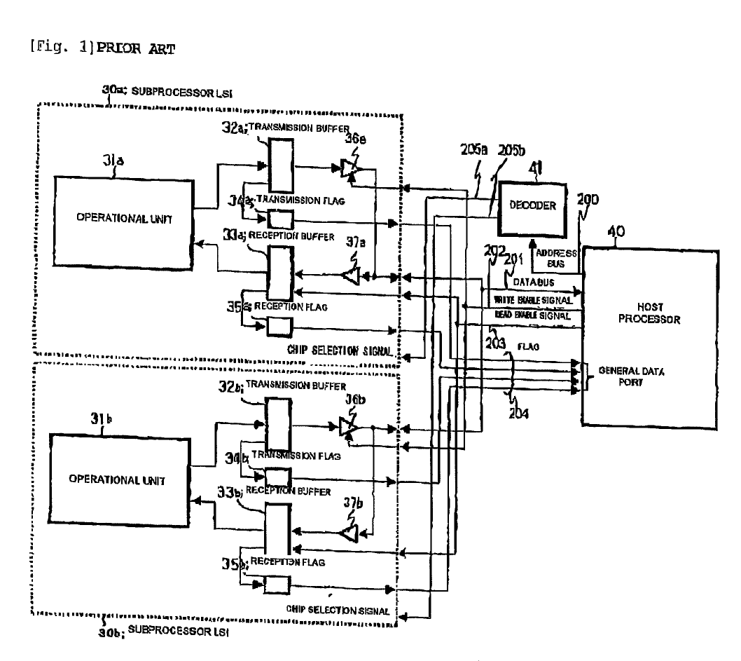

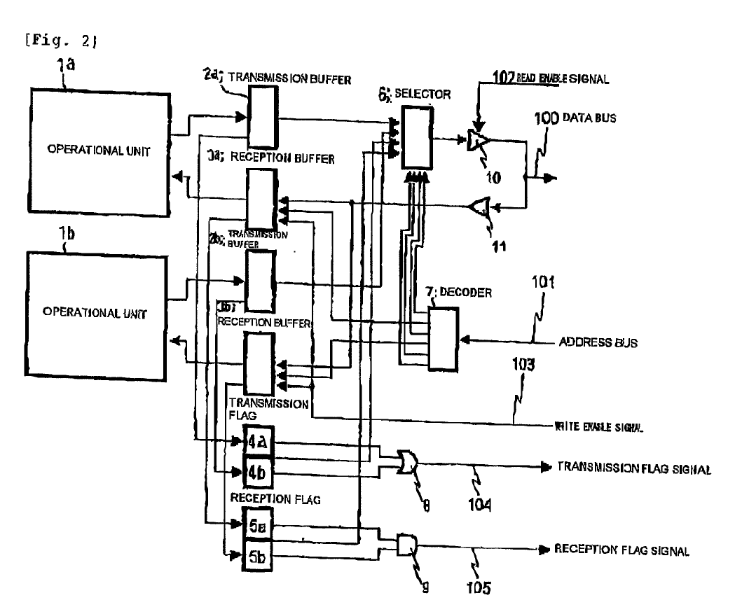

### DESCRIPTION OF THE PREFERRED EMBODIMENTS

Preferred embodiments of the present invention will be specifically explained below. According to an embodiment of the present invention, as an interface circuit for transmitting and receiving data to and from an outer processor, transmission flags (4a, 4b) and reception flags (5a, 5b) for indicating states of transmission buffers (2a, 2b) and reception buffers (3a, 3b), respectively, which are disposed associated with each of operational units (1a, 1b), are assigned to each bit of a register, which can be accessed from the outer processor side in the LSI, in which a plurality of operational units (1a, 1b) are loaded in the same chip. Additionally, a plurality of transmission flags (4a, 4b) are combined into one signal (a transmission flag signal 104), for example, by an OR circuit (8) and a plurality of reception flags (5a, 5b) are combined into one signal (a reception flag signal 105) by an AND circuit (9) so that they are assigned to an outer pins of the LSI.

A plurality of reception flags may be combined into one signal (a reception flag signal 105′) by an OR circuit (9′)

At first, the outer processor refers to the transmission flag signals and the reception flag signals of the outer pin, subsequently, reads a transmission flag register and a reception flag register. Then, the outer processor checks condition of the transmission buffer and the reception buffer to access a necessary transmission buffer and a necessary reception buffer.

The preferred embodiment of the present invention comprises a plurality of the transmission buffers (2a, 2b), which are provided associated with each of a plurality of the operational units (1a, 1b), a plurality of the transmission flag registers (4a, 4b) for storing the transmission flags indicating each sate of the transmission buffers (2a, 2b) in a predetermined bit position, a plurality of the reception buffers (3a, 3b) which are provided associated with each of a plurality of operational units, the reception flag resisters (5a, 5b) for storing the transmission flags indicating each sate of the reception buffers (3a, 3b) in a predetermined bit position, data output from the transmission buffers, output from the transmission flag register and a selector (6) for selecting and outputting the output from the reception flag register on the basis of a selection signal. The output of the selector (6) is output to a data bus via an output buffer and an outer terminal (pin). The preferred embodiment of the present invention further comprises means (8) for combining signals indicating that there is a transmission data into one signal and outputting it as the transmission flag signal (104) when values of a plurality of the transmission flags of the transmission flag register are input and any one of the forgoing plurality of transmission flags indicates that there is a transmission data, means (9) for combining signals indicating that a plurality of reception signals are vacant into one signal and outputting it as the reception flag signal (105) when values of a plurality of the reception flags of the reception flag register are input and the forgoing plurality of reception flags indicate vacancy and a decoder (7) for inputting an address signal to be transmitted form an address bus and decoding it.

According to one embodiment of the present invention, means (9′) may be provided to combine signals indicating that any one of a plurality of the reception flags indicates vacancy into one signal and output it to the outside thereof as a reception flag signal (105′) in the case that when values of a plurality of the reception flags of the reception flag register are input and any one of the forgoing plurality of reception flags indicates vacancy.

Upon writing data, the reception buffer which is designated by the foregoing address signal is activated and upon reading the values of the foregoing transmission buffer, the foregoing transmission flag register and the foregoing reception flag register, the addresses, which are assigned to the foregoing transmission buffers, the foregoing transmission flag register and the foregoing reception flag register, are designated by the foregoing address signal and any one of the foregoing transmission buffers, the foregoing transmission flag register and the foregoing reception flag register is selected to be output via the selector (6) for inputting the signal decoded by the decoder (7) as a selection signal to the data bus.

One preferred embodiment of the present invention comprises a decoder apparatus (22) for decoding a signal to be output from a host processor apparatus to the address bus and outputting a chip selection signal, which activates the selected semiconductor integrated circuit apparatus (22) according to the present invention. When the foregoing host processor apparatus (21) detects that a signal showing that there is a transmission data is output from the foregoing transmission flag signal of the foregoing semiconductor integrated circuit apparatus shows, the foregoing host processor apparatus (21) designates the address of the foregoing transmission flag register and reads the data of the foregoing transmission flag register from the foregoing data bus, and the foregoing host processor apparatus (21) specifies the transmission buffer, in which there is transmission from the foregoing transmission flag register, outputs the address of the foregoing designated transmission buffer to the foregoing address bus and reads the data of the foregoing transmission buffer.

Alternatively, upon writing and accessing with respect to the foregoing semiconductor integrated circuit apparatus (20) according to the present invention by the foregoing host processor (21), when the foregoing reception flag signal of the foregoing semiconductor integrated circuit apparatus shows all of a plurality of the foregoing reception buffers are vacant, the foregoing host processor (21) designates any buffer of a plurality of the reception buffers by the address bus to write the data and when the foregoing reception flag signal (105) does not show all of a plurality of the foregoing reception buffers are vacant, the foregoing host processor (21) designates the address of the foregoing reception flag register and read the data of the foregoing reception flag register from the data bus, specifies a vacant reception buffer from the foregoing reception flag register, outputs the address of the foregoing specified reception buffer to the foregoing address bus and writes the data via the foregoing data bus in the foregoing reception buffer.

Alternatively, upon writing and accessing with respect to the foregoing semiconductor integrated circuit apparatus (20) according to the present invention by the foregoing host processor (21), when the foregoing reception flag signal (105′) of the foregoing semiconductor integrated circuit apparatus shows one of a plurality of the foregoing reception buffers is vacant, the foregoing host processor apparatus (21) designates the address of the foregoing reception flag register and reads the data of the foregoing reception flag register from the foregoing data bus, and the foregoing host processor apparatus (21) specifies a vacant reception buffer from the reception flag register, outputs the address of the foregoing designated reception buffer to the foregoing address bas and writes the data in the foregoing reception buffer via the data bus.

The above-described embodiments of the invention will be better understood by explaining examples of the present invention with reference to the accompanying drawings.

FIG. 2 illustrates a constitution of an example of the present invention. With reference to FIG. 2, a plurality of operational units are loaded on one integrated circuit in a subprocessor and a part of an interface circuit as communication means with respect to an outer host processor is shared between a plurality of the operational units. In the constitution shown in FIG. 2, two operational units are disposed on the same chip for convenience of explanation. According to the present invention, the operational units are not limited to two units, but, of course, more than two operational units may be disposed on the same chip.

With reference to FIG. 2, according to an example of the present invention, two operational units 1a and 1b are loaded on the chip. Each of the operational units 1a and 1b is connected to a transmission buffer 2a, a transmission buffer 2b and a reception buffer 3a, a reception buffer 3b, respectively.

According to an example of the present invention, since a plurality of transmission buffers and a plurality of reception buffers are disposed on the same chip, a decoder 7 is provided to decode an address bus 101. A decode result signal of the decoder 7 is input as a signal for selecting the reception buffers 3a and 3b and a selection signal to a selector 6. The selected reception buffer fetches a data bus signal and a signal selected by the selector 6 among outputs of the transmission buffer is output via a transmission driver 10 to a data bus 100.

The address signal decides which one of the transmission buffers 2a and 2b should be selected. Then, the transmission buffer to be selected is selected by the selector 6 for inputting the decode signal of the decoder 6 for inputting the address.

One of the reception buffers 3a and 3b is designated by the address and the designated reception buffer is selected by a decoding result of the decoder 7.

Transmission buffers 4a and 4b for indicating that data is written in the transmission buffers 2a and 2b are assigned for each bit in a predetermined bit field of a register having a plurality of bits width, so that they construct a transmission flag register.

The transmission flag register is constructed, in such a manner that an outer host processor (not illustrated) of a LSI constituting an example of the present invention can read all contents thereof by one access.

In the same way, reception flags 5a and 5b are assigned for each bit in a predetermined bit field of a register having a plurality of bits width and constitute a reception flag register. The reception flag register is constructed, in such a manner that an outer host processor of a LSI constituting an example of the present invention can read all contents thereof by one access.

Output from the transmission flag register including the transmission flags 4a and 4b and output from the reception flag register including the reception flags 5a and 5b are input to the selector 6. Addresses, which are designated by the outer host processor, are assigned to the transmission flag register and the reception flag register, respectively. In the case that this address is designated by the address signal of the address bus 101, the output from the transmission flag register including the transmission flags 4a and 4b or the output from the reception flag register including the reception flags 5a and 5b are output to the data bus 101 via the selector 6, of which selection signal comprises the decode signal of the decoder 7.

Alternatively, in order to notify the states of the transmission buffers 2a and 2b and the reception buffer 3a and 3b to the outside, the transmission flag 4a and 4b are connected to the outer pin via an OR circuit 8 as the transmission flag signal 104 and the reception flags 5a and 5b are connected to the outer pin via an AND circuit 9 as the reception flag signal 105. With respect to the transmission flags 4a and 4b, in the case that at least one of these has a flag value “1”, “1” is output to the transmission flag signal 104 as the output of the OR circuit 8. With respect to the reception flags 5a and 5b, in the case that both of them have a flag value “1” (both of them are vacant), the reception flag signal 105 as the output from the AND circuit 9 should be “1” to be output from the outer pin.

All reception buffers 3a and 3b share a write enable signal 103 from the host processor. Alternatively, all transference buffers 2a and 2b share a read enable signal 102 with respect to the flag register.

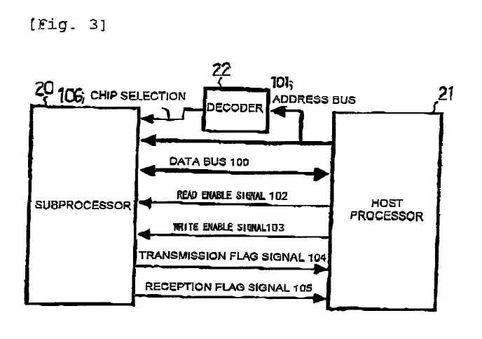

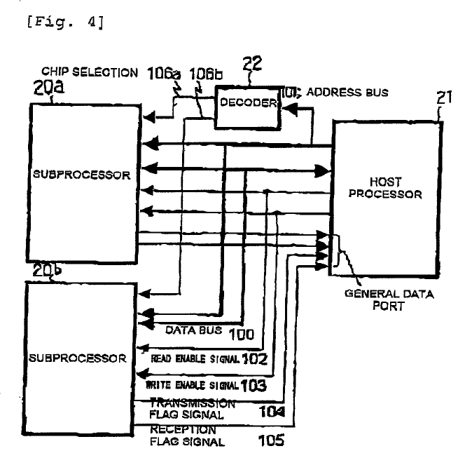

The write enable signal 103 and the read enable signal 102 determine a selection object as well as a decode result of the decoder 7 for inputting the address signal. Although it is not indicated in FIG. 2, a chip selection signal for activating (effecting) the interface circuit in the chip is disposed in the outer pin of a subprocessor LSI (refer to FIG. 3). Only if a chip selection signal pin is set in active, operation of a resource within the chip is capable of being performed. The chip selection signal pin is a countermeasure for only effecting the selected processor in the case that a plurality of the subprocessors LSI having the constitution shown in FIG. 2 are provided.

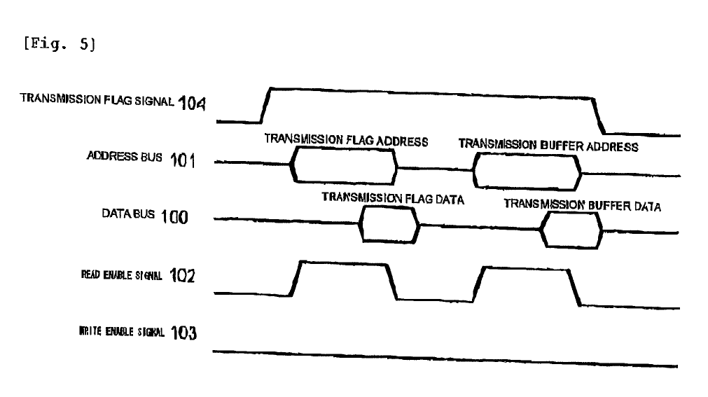

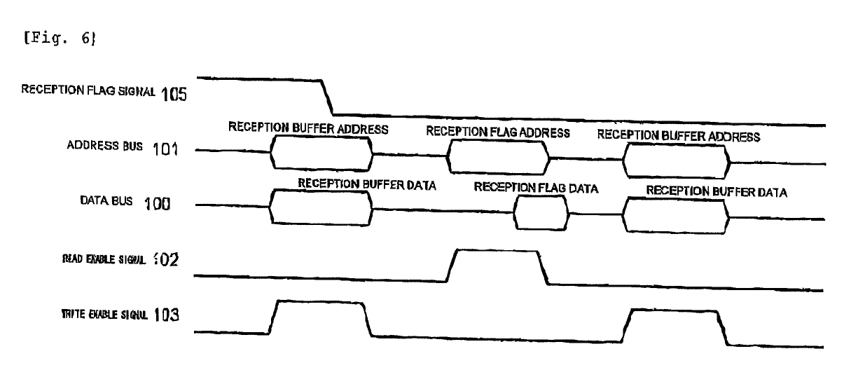

FIG. 3 and FIG. 4 illustrate an example of a connection state between the subprocessor LSI and the host processor according to an example of the present invention.

FIG. 3 illustrates a constitution such that one of the subprocessors LSI 20 show in FIG. 2 is connected to the host processor 21. With reference to FIG. 3, since the bus of the host processor 21 is connected to an outer memory and a peripheral devices or the like in addition to the subprocessors LSI 20, the address bus 101 is connected to the decoder 22 and the decoder 22 asserts the chip selection signal 106 when the input address signal has a predetermined address pattern.

Further, a part of the address bus 101 is connected to the address bus of the subprocessors LSI 20. The data bus 100 is connected to the subprocessors LSI 20 and the host processor 21.

The read enable signal 102 and the write enable signal 103 for the subprocessors LSI 20 are also connected to a signal associated with the host processor 21.

In order to transmit the transmission flag signal 104 and the reception flag signal 105 to be output from the subprocessors LSI 20 to the host processor 21, if there is a general data port in the host processor 21, the subprocessors LSI 20 may be connected to the general data port or the subprocessors LSI 20 may be connected to an interruption input of the host processor 21.

FIG. 4 illustrates a constitution such that the subprocessors LSI 20a and 20b shown in FIG. 2 are connected to the host processor 21. The subprocessors LSI 20a and 20b are connected to the data bus 100, the address bus 101, the read enable signal 102 and the write enable signal 103 as same as the constitution such that there is one subprocessor LSI shown in FIG. 3. Therefore, the same signal may be connected to two subprocessors as it is.

A part of the address bus is input in the decoder 22 to generate the chip selection signal. The chip selection signals 106a and 106b are asserted by different addresses so that different addresses are assigned to two subprocessors LSI and the chip selection signals 106a and 106b are input to the subprocessors LSI 20a and 20b, respectively.

Since the transmission flag signal 104 and the reception flag signal 105 are output from the respective subprocessors LSI 20a and 20b, they are input in the general port or the like of the host processor 21, separately.

FIG. 5 illustrates timing waveforms of each of signals (the transmission flag signal 104, the address bus 101, the data bus 100, the read enable signal 102 and the write enable signal 103) in the case that the host processor 21 obtains the data from the subprocessor LSI 20 according to an example of the present invention.

When the subprocessor LSI 20 disposes the data in the transmission buffer 2a, the transmission flag 4a turns on (High level) and the transmission flag signal 104 is asserted via the OR circuit 8.

If the host processor 21 detects that the transmission flag signal 104 is asserted via the OR circuit 8, at first, reads the transmission flag register and checks which transmission buffer in the transmission buffers 2a and 2b has the data.

Since the transmission flags 4a and 4b associated with the transmission buffers 2a and 2b of each of operational units are assigned to predetermined bit positions in the transmission flag register, it can be detected which transmission buffer has the data by referring the bit “1”. In order for the host processor 21 to read the transmission flag register, the transmission flag address may be output to the address bus 101 and the read enable signal 102 may be asserted. After the delay time for reading, a content (data) of the transmission flag (transmission flag register) is read on the data bus 100.

If it is known that there is the data in the transmission buffer 2a from the content of the transmission flag register, the host processor 21 reads the data from the transmission buffer 2a. In other words, the host processor 21 outputs the address of the transmission buffer 2a to the address bus 101 and asserts the read enable signal 102, a value of the transmission buffer 2a (transmission buffer data) appears in the data bus 100.

FIG. 5 illustrates timing waveforms of each of signals in the case that the host processor 21 provides the data to the subprocessor LSI 20 according to an example of the present invention.

The reception flag signal 105 comprises a signal for indicating that both of the reception buffers 3a and 3b are vacant. When this reception flag signal 105 is asserted (in the case of “1”), since both of the reception buffers 3a and 3b are vacant, it is not necessary to refer to the reception flag register and any reception buffer is capable of being written.

The host processor 21 provides the data to the operational unit 1a, in such a manner that it writes the data in the reception buffer 3a. The host processor 21 provides the address of the reception buffer 3a to the address bus 101, outputs the written data to the data bus 100 and asserts the write enable signal 103, so that it becomes capable of writing the data in the reception buffer 3a.

When the data is written in the reception buffer 3a, the reception flag 5a becomes “0” from vacancy and the reception flag signal 105 is deasserted (becomes “0”) through the AND circuit 9.

Alternatively, the reception flag signal 10 is asserted again when the operational unit 1a reads the reception flag 5a (refer to FIG. 2) to be vacant.

On the other hand, even when the flag signal 105 is deasserted, not all reception buffers are filled. Therefore, it may be possible to check the vacant reception buffers and write them. In this case, at first, reading the reception flag register, the vacant reception flags 5a and 5b check the reception buffer showing the value “1”. If there is a vacant reception buffer, this vacant reception buffer is selected by the address signal to be written.

It will be explained the case that the flag signal 105 is deasserted in the state that for example, the reception buffer 3a is written the data, the data is written from the host processor 21 to the reception buffers 3b for example.

At first, the host processor 21 outputs the address of the reception flag register to the address bus 101 and asserts the read enable signal 102. As a result of it, the data of the reception flag register appears on the data bus 100. Then, the host processor 21 receives the reception flag register on the data bus 100 to check the vacant reception buffers from the received reception flag register.

When it is found that the reception flags 5b associated with the reception buffers 3b is “1” and the reception buffers 3b is vacant, the address of the reception buffers 3b is transmitted to the address bus 101, the written data is output to the data bus 100 and the write enable signal 103 is asserted.

According to the above-described example, the transmission flag register to be accessed from the host processor and the address of the reception flag register are separately assigned. However, in the case that the transmission flag and the reception flag can be hold in a data length (a bit width which can be accessed one time), the transmission flag register and the reception flag register may be assigned to the same address to be accessed at the same time.

Alternatively, the above-described example is constructed, in such a manner that the reception flag signal 105 is connected to the outer signal pin. However, in the case that the host processor always refers the reception flag register upon writing the data from the host processor, this reception flag signal 105 is not necessary. On the other hand, in the case that the reception flag signal 105 is output from the outer terminal and the host processor checks the reception flag signal 105 to write the data, it is capable of speeding up the data access.

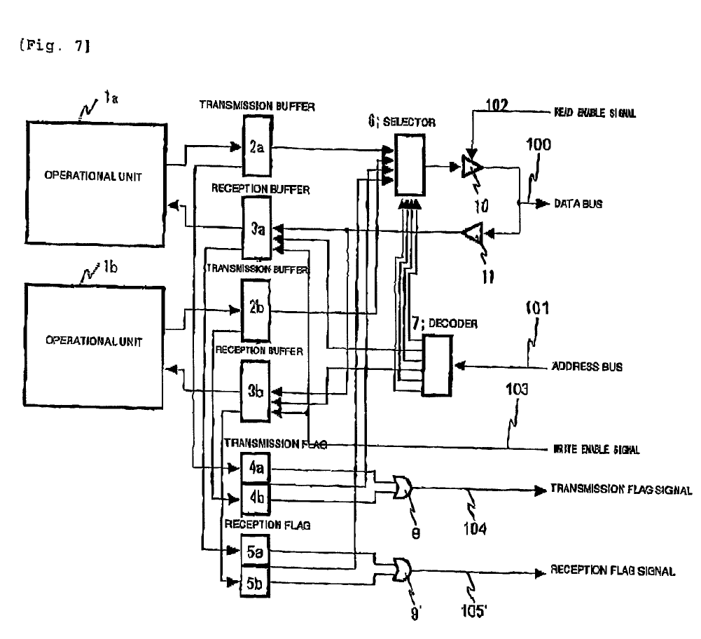

FIG. 7 illustrates another example of the present invention. In the present example, the reception flag signal (105) and the AND circuit (9) for generating the reception flag signal (105) in the construction of FIG. 2 are changed, so that an OR circuit (9′) generates a reception flag signal (105′) to output it to the outside of the chip. In this case, when there is at least one vacant reception buffer, the reception flag signal (105′) is asserted and when all reception buffers are filled, the reception flag signal (105′) is deasserted. Means for referring to this signal by the host processor is the same as that in the above-described example.

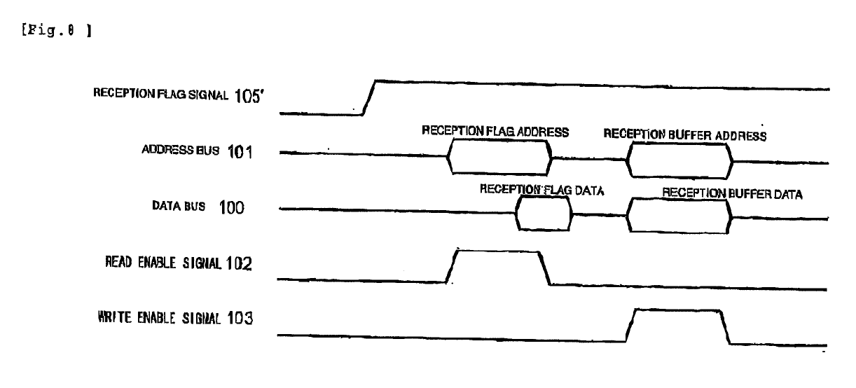

FIG. 8 illustrates timing waveforms in the case that the host processor writes the data in the subprocessor. In the case that all reception flags are filled, the reception flag signal 105′ shows deassertion. When one of the subprocessors reads the data within the reception buffer, the reception buffer becomes vacant, so that the reception flag signal 105═ is asserted. The host processor detects this signal, reads the reception flag register, checks which of the reception buffers is vacant and writes the data, which the host processor wishes to transmit to the subprocessor, in the reception buffer. This method is suitable for the case that processing of the subprocessor is slower the that of the host processor or the case that many items of data are transmitted from the host processor to the subprocessor.

Alternatively, it is needless to say that setting of a logic of a signal (activating it by a High level or a Low level or the like) such as the transmission flag, the reception flag, the transmission flag signal, the reception flag signal, the read enable signal and the write enable signal or the like is not limited to the construction of the above example. For example, when there is data in the reception buffers 3a and 3b with respect to the reception flags 5a and 5b, the flag value may be “1” (when the reception buffers 3a and 3b are vacant, the flag value may be “0”). In this case, in place of the AND circuit 9 in FIG. 2, an NOR circuit is employed. When the both of the reception flags 5a and 5b are vacant, the reception flag signal as an output of the NOR circuit is “1”.

As described above, according to the present invention, the following described effects are provided.

A first effect of the present invention is to delete the number of the signal pins of the LSI chip, in which a plurality of operational units are loaded.

A reason of the first effect of the present invention is that the transmission flags and the reception flags showing the states of a plurality of the transmission buffers and the reception buffers in the interface circuit with respect to the host processor are combined to one signal to be output as the outer pin and the detailed flag is constructed so as to be referred to by the host processor as a register.

A second effect of the present invention is to simplify the connection state of the host processor and the subprocessor and the access of the data.

A reason of the second effect of the present invention is that the present invention is applied in accordance with the connection state which is substantially identical to that of a conventional interface and it is constructed, in such a manner that the transmission flags and the reception flags are read by the same method as that of reading the transmission buffers upon access.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching herein set forth.

What is claimed is:

1. An interface circuit between processors comprising:
an integrated circuit apparatus including a plurality of operational units; wherein a plurality of said operational units transmits data to a processor in the outside of said integrated circuit apparatus via transmission buffers, which are disposed associated with each of said operational units, respectively;
a register group, in which transmission flags showing there is data in each of said transmission buffers or not are assigned in different bit positions, respectively; and
means for enabling said register group to be referred at the same time from said processor in the outside of said integrated circuit apparatus.

2. An interface circuit between processors comprising:
an integrated circuit apparatus including a plurality of operational units; wherein a plurality of said operational units receive data from a processor in the outside of said integrated circuit apparatus via reception buffers, which are disposed associated with each of said operational units, respectively;
a register group in which reception flags showing each of said reception buffers is vacant or not are assigned in different bit positions, respectively; and
means for enabling said register group to be referred at the same time from said processor in the outside of said integrated circuit apparatus.

3. An interface circuit between processors according to claim 1, comprising an outer terminal for outputting a logical addition output of a value of each element of said register group to the outside.

4. An interface circuit between processors according to claim 2, comprising an outer terminal for outputting a logical product output of a value of each element of said register group to the outside.

5. A semiconductor integrated circuit apparatus, comprising:
a plurality of transmission buffers, which are disposed, associated with each of a plurality of inner circuit units;
a transmission flag register for storing a plurality of transmission flags showing states of a plurality of said transmission buffers, respectively, on predetermined positions; and
a selector for inputting output from a plurality of said transmission buffers and output from said transmission flag register, selecting any one of these signals on the basis of a selection signal and outputting the selected signal; wherein the output from said selector is output via an output buffer from a data terminal.

6. A semiconductor integrated circuit apparatus according to claim 5, comprising means for inputting values of a plurality of transmission flags of said transmission flag register and outputting a transmission flag signal, which shows at least one of a plurality of said transmission flags indicates that there is transmission data or all of a plurality of said transmission flags are vacant by two values, from an outer terminal.

7. A semiconductor integrated circuit apparatus, comprising;
a plurality of transmission buffers, which are disposed, associated with each of a plurality of inner circuit units;
a transmission flag register for storing a plurality of transmission flags showing states of a plurality of said transmission buffers, respectively, on predetermined positions;
a plurality of reception buffers, which are disposed, associated with each of a plurality of inner circuit units;
a reception flag register for storing reception flags showing states of a plurality of said reception buffers, respectively, on predetermined positions; and
a selector for inputting output from a plurality of said transmission buffers, output from said transmission flag register and output from said reception flag register, selecting any one of these signals on the basis of a selection signal and outputting the selected signal; wherein the output from said selector is output via an output buffer from a data terminal.

8. A semiconductor integrated circuit apparatus according to claim 7, comprising:
means for inputting values of a plurality of transmission flags of said transmission flag register and outputting a transmission flag signal, which shows at least one of a plurality of said transmission flags indicates that there is transmission data or all of a plurality of said transmission flags are vacant by two values, from a first outer terminal; and
means for inputting values of a plurality of reception flags of said reception register and outputting a reception flag signal, which shows all of a plurality of said reception flags are vacant or at least one of a plurality of said reception flags indicates that there is reception data by two values, from a second outer terminal.

9. A semiconductor integrated circuit apparatus according to claim 7 or 8, wherein said inner circuit units comprise operational units.

10. A semiconductor integrated circuit apparatus according to claim 7, comprising a decoder for inputting an address signal to be transmitted from an address bus and decoding it; wherein said semiconductor integrated circuit activates a reception buffer which is designated by said address signal upon writing data, designates addresses, which are assigned to said transmission buffer, said transmission flag register and said reception flag register, by said address signal upon reading the values of said transmission buffer, said transmission flag register and said reception flag register and output, which is selected via said selector for inputting a signal which is decoded by said decoder for decoding said address signal as said selection signal, is output from said data terminal.

11. A semiconductor integrated circuit apparatus comprising:
a plurality of transmission buffers, which are disposed, associated with each of a plurality of operational units;
a transmission flag register for storing a plurality of transmission flags showing states of a plurality of said transmission buffers, respectively, on predetermined bit positions;
a plurality of reception buffers, which are disposed, associated with each of a plurality of operational units;
a reception flag register for storing a plurality of reception flags showing states of a plurality of said reception buffers, respectively on predetermined bit positions;
a selector for selecting output from a plurality of said transmission buffers, output from said transmission flag register and output from said reception flag register on the basis of a selection signal and outputting the selected signal via an output buffer to a data bus;
means for inputting values or a plurality of transmission flags of said transmission flag register and outputting a transmission flag signal, which shows at least one of a plurality of said transmission flags indicates that there is transmission data or all of a plurality of said transmission flags are vacant by two values, from a first outer terminal;
means for inputting values of a plurality of reception flags of said reception register and outputting a reception flag signal, which shows all of a plurality of said reception flags are vacant or at least one of a plurality of said reception flags indicates that there is reception data by two values, from a second outer terminal; and
a decoder for inputting an address signal to be transmitted from the address bus and decoding it; wherein upon writing data, the data from said data bus is written in the reception buffer which is designated by said address signal and is selected by the decode signal from said decoder and upon reading the values of said transmission buffers, said transmission flag register and said reception flag register, the addresses, which are assigned to said transmission buffers, said transmission flag register and said reception flag register, are designated by said address signal and selects any one of said transmission buffers, said transmission flag register and said reception flag register to output it via said selector for inputting the signal decoded by said decoder as said selection signal to said data bus.

12. A processor system comprising:
one or a plurality of the semiconductor integrated circuit apparatus(es) according to claim 11;
a host processor apparatus for communicating with said semiconductor integrated circuit apparatus; and
a decoder apparatus for inputting a signal to be output from said host processor apparatus to the address bus and decoding it; and outputting a chip selection signal, which activates the selected semiconductor integrated circuit; wherein when said host processor apparatus detects that said transmission flag signal from said first outer terminal of said semiconductor integrated circuit apparatus shows there is a transmission data, said host processor apparatus designates the address of said transmission flag register and reads the data of said transmission flag register from said data bus, and said host processor apparatus specifies the transmission buffer, in which there is transmission from said transmission flag register, outputs the address of said specified transmission buffer to said address bus and reads the data of said transmission buffer.

13. A processor system according to claim 12; wherein upon writing and accessing with respect to said semiconductor integrated circuit apparatus by said host processor, when said host processor apparatus detects that said reception flag signal from said second outer terminal of said semiconductor integrated circuit apparatus shows all of a plurality of said reception buffers are vacant, said host processor designates any buffer of a plurality of said reception buffers by the address bus to write the data from said data bus.

14. A processor system according to claim 12; wherein upon writing and accessing with respect to said semiconductor integrated circuit apparatus by said host processor, when said reception flag signal from said second outer terminal of said semiconductor integrated circuit apparatus does not show all of a plurality of said reception buffers are vacant, said host processor designates the address of said reception flag register and reads the data of said reception flag register from said data bus, specifies a vacant reception buffer from said reception flag register, outputs the address of said specified reception buffer to said address bus and writes the data via said data bus in said reception buffer.

15. A processor system according to claim 13; wherein upon writing and accessing with respect to said semiconductor integrated circuit apparatus by said host processor, when said reception flag signal from said second outer terminal of said semiconductor integrated circuit apparatus does not show all of a plurality of said reception buffers are vacant, said host processor designates the address of said reception flag register and reads the data of said reception flag register from said data bus, specifies a vacant reception buffer from said reception flag register, outputs the address of said specified reception buffer to said address bus and writes the data via said data bus in said reception buffer.

16. An interface circuit between processors according to claim 2, comprising an outer terminal for outputting a logical addition output of a value of each element of said register group to the outside.

17. A semiconductor integrated circuit apparatus according to claim 7 comprising:
means for inputting values of a plurality of transmission flags of said transmission flag register and outputting a transmission flag signal, which shows at least one of a plurality of said transmission flags indicates that there is transmission data or all of a plurality of said transmission flags are vacant by two values, from a first outer terminal; and
means for inputting values of a plurality of reception flags of said reception register and outputting a reception flag signal, which shows at least one of a plurality of said reception flags is vacant or there are data in all of a plurality of said reception flags by two values, from a second outer terminal.

18. A semiconductor integrated circuit apparatus comprising:
a plurality of transmission buffers, which are disposed, associated with each of a plurality of operational units;
a transmission flag register for storing a plurality of transmission flags showing states of a plurality of said transmission buffers, respectively, on predetermined positions;
a plurality of reception buffers, which are disposed, associated with each of a plurality of operational units;
a reception flag register for storing reception flags showing states of a plurality of said reception buffers, respectively, on predetermined positions;
a selector for selecting inputting output from a plurality of said transmission buffers, output from said transmission flag register and output from said reception flag register on the basis of a selection signal and outputting the selected signal via an output buffer to a data bus;
means for inputting values of a plurality of transmission flags of said transmission flag register and outputting a transmission flag signal, which shows at least one of a plurality of said transmission flags indicates that there is transmission data or all of a plurality of said transmission flags are vacant by two values, from a first outer terminal;
means for inputting values of a plurality of reception flags of said reception register and outputting a reception flag signal, which shows at least one of a plurality of said reception flags is vacant or there are data in all of a plurality of said reception flags by two values, from a second outer terminal; and
a decoder for inputting an address signal to be transmitted from the address bus and decoding it; wherein upon writing data, the data from said data bus is written in the reception buffer which is designated by said address signal and is selected by the decode signal from said decoder and upon reading the values of said transmission buffers, said transmission flag register and said reception flag register, the addresses, which are assigned to said transmission buffers, said transmission flag register and said reception flag register, are designated by said address signal and selects any one of said transmission buffers, said transmission flag register and said reception flag register to output it via the selector for inputting the signal decoded by the decoder as a selection signal to the data bus.

19. A processor system comprising:
one or a plurality of the semiconductor integrated circuit apparatus(es) according to claim 18;
a host processor apparatus for communicating with said semiconductor integrated circuit apparatus; and
a decoder apparatus for inputting a signal to be output from said host processor apparatus to the address bus and decoding it; and outputting a chip selection signal, which activates the selected semiconductor integrated circuit; wherein when said host processor apparatus detects that said transmission flag signal from said first outer terminal of said semiconductor integrated circuit apparatus shows there is a transmission data, said host processor apparatus designates the address of said transmission flag register and reads the data of said transmission flag register from said data bus, and said host processor apparatus specifies the transmission buffer in which there is transmission from said transmission flag register, outputs the address of said designated transmission buffer to said address bus and reads the data of said transmission buffer.

20. A processor system according to claim 19; wherein upon writing and accessing with respect to said semiconductor integrated circuit apparatus by said host processor, when said reception flag signal from said second outer terminal of said semiconductor integrated circuit apparatus shows at least one of a plurality of said reception buffers is vacant, said host processor designates the address from said reception flag register and reads the data of said reception flag register from said data bus, specifies a vacant reception buffer from said reception flag register, outputs the address of said specified reception buffer to said address bus and writes the data via said data bus in said reception buffer.
